(19) United States
(12) Patent Application Publication
(10) Pub. No.: US 2008/0222958 A1
(43) Pub. Date: Sep. 18, 2008

(54) Safety Window

(76) Inventor: David De La Cruz, Middletown, CT (US)

Correspondence Address: LAW OFFICE OF MICHAEL A. BLAKE, 112 BROAD STREET, MILFORD, CT, 06460, US

(21) Appl. No.: 11/686,519

(22) Filed: Mar. 15, 2007

(51) Int. Cl. E05D 15/24

(52) U.S. Cl. 49/181

(57) ABSTRACT

A safety window comprising: a window frame, with a right inner surface, a left inner surface, a top, and a bottom; a lower sash in vertical slideable communication with window frame, the lower sash with a top and a bottom; an upper sash in vertical slideable or fixed communication with the window frame, the upper sash with a top and a bottom; a lock apparatus located on the top of the lower sash and the bottom of the upper sash and configured to reversibly lock the lower sash with respect to the upper sash, when locked the upper sash is located at the top of the frame, and the lower sash is located at the bottom of the frame; a first plurality of holes located on the right inner surface of the window frame; a second plurality of holes located on the left inner surface of the window frame; a first extendible pin located in the top of the bottom sash, and configured to removeably engage at least one of the first plurality of holes; a second extendible pin located in the top of the bottom sash, and configured to removeably engage at least one of the second plurality of holes; a first sliding member located at the top of the bottom sash, and in operable communication with the first pin; a second sliding member located at the top of the bottom sash, and in operable communication with the second pin; a first frame member located on the interior right surface of the window frame, the first frame member configured to be slideable communication with the first extendible pin when the first extendible pin is in a normal position; a second frame member located on the interior left surface of the window frame, the second frame member configured to be slideable communication with the second extendible pin when the second extendible pin is in a normal position.

### TECHNICAL FIELD

The present invention relates to the field of safety windows. More particularly, the present invention relates to a device to allow a user to lock a window sash in place relative to a window frame.

### BACKGROUND

Opening windows to obtain fresh ambient air is appealing and pleasurable in various warm weather seasons. In multi-story homes and buildings, however, open windows can be problematic and present a potential safety hazard. In this, an open window is an attraction to a child, a mentally impaired adult or a pet who approaches the window opening to gaze outside. Disaster may strike if the child climbs onto an open window sill or even leans out a window to look down. Any fall is almost certain to result in death or serious bodily injury. Moreover, the secondary emotional trauma to a parent attendant such a tragedy may be debilitating.

The dangers associated with an open window has lead to a number of proposed solutions. Many residential apartment buildings have converted to sealed windows having a small vent which may be opened to allow fresh air to enter the living space. The obvious disadvantages associated with these window systems is that the window can not be opened very much and such systems are clearly a fire hazard.

Other prior art safety systems utilize a permanently installed bar cover which is screwed into the frame of the window. This system has several limitations. First, it is very unattractive to have permanently installed bars covering a window opening. Second, the fastening elements which are needed to secure a bar cover to a window frame may cause extensive damage to the frame. Third, these permanent bars create a prison atmosphere and block any egress which may be necessary in the event of a fire or other emergency.

Another prior art attempt utilizes a plurality of telescopic rods or collapsible scissor bars which have one end secured to the window sill and the other end secured to a window sash. When the window sash is raised to an open position, the rods or bars extend and cover the window opening. This system has several recognized difficulties. First, the presence of the rods is obvious whether the window is open or closed which detracts from the aesthetic appearance of the window. Second, the telescopic rods are an expensive addition to the window system and are not easily manufactured. Third, the system must be screwed into the window sash and sill which causes permanent damage to the window and surrounding frame.

Another prior art attempt utilizes a plurality of bars which are secured to the underside of the lower rail of a lower window sash. When the lower window sash is in a closed position, the bars are housed beneath the window sill in an adjacent wall. As the lower window sash is raised the bars are raised into the window opening thereby providing a safety feature. Several disadvantages are recognized. First, this system involves major alterations to the window system and surrounding walls in order to house the bars. Second, the system is a costly alternative to prior art safety systems. Third, the system causes permanent damage to the window sash and frame.

Yet another prior art attempt utilizes a bar system which travels in vertical guides secured to the window frame. As a window is opened the bars occupy the opening. This prior art attempt utilizes a plurality of runners which guide an attached bar. This complex system has several recognized limitations. First, the system utilizes complex parts which increases the difficulty of installation and increases the production cost. Second, the system does not provide a means for housing the bars when the window is in a closed position. Third, the system provides no easy and convenient way to disengage the safety system when not needed. Fourth, the system requires major alterations to an existing window structure.

The difficulties and limitations suggested in the preceding are not intended to be exhaustive, but rather are among many which demonstrate that although significant attention has been devoted to window safety systems, such systems appearing in the past will admit to worthwhile improvement.

Thus there is a need for a safety window that overcomes the above referenced and other disadvantages.

### SUMMARY

The disclosed invention relates to a safety window comprising: a window frame, with a right inner surface, a left inner surface, a top, and a bottom; a lower sash in vertical slideable communication with window frame, the lower sash with a top and a bottom; an upper sash in vertical slideable communication with the window frame, the upper sash with a top and a bottom; a lock apparatus located on the top of the lower sash and the bottom of the upper sash and configured to reversibly lock the lower sash with respect to the upper sash, when locked the upper sash is located at the top of the frame, and the lower sash is located at the bottom of the frame; a first plurality of holes located on the right inner surface of the window frame; a second plurality of holes located on the left inner surface of the window frame; a first extendible pin located in the top of the bottom sash, and configured to removeably engage at least one of the first plurality of holes; a second extendible pin located in the top of the bottom sash, and configured to removeably engage at least one of the second plurality of holes; a first sliding member located at the top of the bottom sash, and in operable communication with the first pin; a second sliding member located at the top of the bottom sash, and in operable communication with the second pin; a first frame member located on the interior right surface of the window frame, the first frame member configured to be slideable communication with the first extendible pin when the first extendible pin is in a normal position; a second frame member located on the interior left surface of the window frame, the second frame member configured to be slideable communication with the second extendible pin when the second extendible pin is in a normal position.

The disclosed invention also relates to a safety window comprising: a window frame, with a right inner surface, a left inner surface, a top, and a bottom; a lower sash in vertical slideable communication with window frame, the lower sash with a top and a bottom; an upper sash fixed in the window frame, the upper sash with a top and a bottom; a lock apparatus located on the top of the lower sash and the bottom of the upper sash and configured to reversibly lock the lower sash with respect to the upper sash, when locked the upper sash is located at the top of the frame, and the lower sash is located at the bottom of the frame; a first plurality of holes located on the right inner surface of the window frame; a second plurality of holes located on the left inner surface of the window frame; a first extendible pin located in the top of the bottom sash, and configured to removeably engage at least one of the first plurality of holes; a second extendible pin located in the top of the bottom sash, and configured to removeably engage at least one of the second plurality of holes; a first sliding member located at the top of the bottom sash, and in operable communication with the first pin; a second sliding member located at the top of the bottom sash, and in operable communication with the second pin; a first frame member located on the interior right surface of the window frame, the first frame member configured to be slideable communication with the first extendible pin when the first extendible pin is in a normal position; a second frame member located on the interior left surface of the window frame, the second frame member configured to be slideable communication with the second extendible pin when the second extendible pin is in a normal position.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of the disclosed safety window;

FIG. 2 is a perspective close-up view of the lower sash with the pin in a retracted position;

FIG. 3 is a perspective close-up view of the lower sash with the pin in a normal position; and

FIG. 4 is a perspective close-up view of the lower sash with the pin in an extended position;

### DETAILED DESCRIPTION

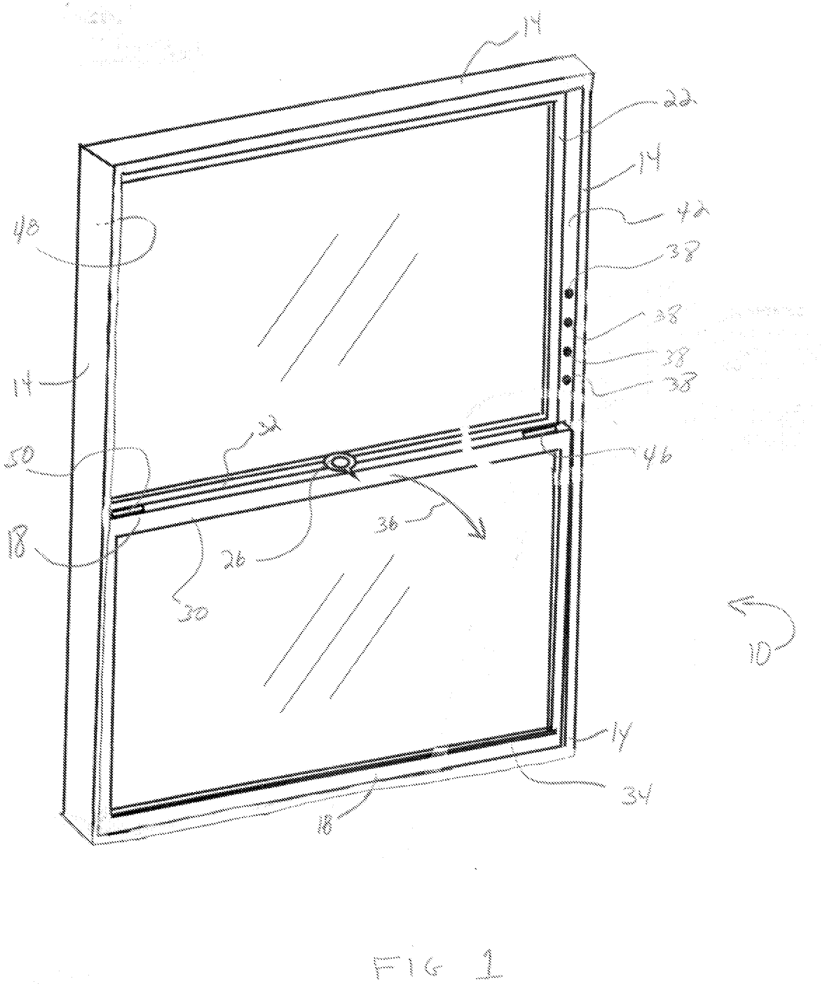

FIG. 1 is perspective view of the disclosed safety window 10. The window 10 comprises a window frame 14, a slideable lower sash 18 and a slideable or fixed position upper sash 22. The lower sash 18 may or may not, depending on construction choice, slide up and down within the window frame 14 and relative to the upper sash 22. Similarly, the upper sash 22 can slide up and down within the window frame 14 and relative to the lower sash 18. The window 10 has a window lock 26 that is configured to lock in position the upper sash 22 with respect to the lower sash 18. The lock 26 may have a first portion of the lock 26 located on the top 30 of the lower sash 18, and a second portion of the lock 26 located on the bottom 32 of the upper sash 22. When locked, the first portion of the lock 26 and the second portion of the lock 26 connect, thereby locking the window with the upper sash 22 located at the top of the window frame 14, and the lower sash 18 located at the bottom of the window frame 14. Additionally, the lower sash 18 is configured to tilt out of the window frame 14 in a manner familiar to one of ordinary skill in the art. When the lower sash 18 is tilted out of the frame the top 30 of the sash 18 moves generally in the direction of the arrow 36 out of the frame and pivots about the bottom 34 of the lower sash 18. Additionally, there are a plurality of holes 38 located on both the right inner vertical surfaces 42 of the window frame 14 and the left inner vertical surface 48 (not visible in this view) of the window frame 14. Located on the top 30 of the lower sash 18 is a first sliding member 46 and a second sliding member 50. The first and second sliding members 46, 50 are each respectively in communication with a first pin 54 (not visible in this Figure, but visible in FIGS. 2-4) and second pin 58 (not visible in this Figure), respectively, both located in the top 30 of the sash 18. The pins 54, 58 are configured to be extendible out of the top 30 of the sash 18 and to retract back within the top 30 of the sash 18.

FIG. 2 shows a perspective close up view of the top 30 of the lower sash 18. In this view, the pin 54 is shown in a retracted position. The pin 54 may be put in this retracted position by moving the sliding member 46 until the pin is in the retracted position. Although not shown, the pin 58, on the other side of the top 30 of the lower sash 18 may be put in the retracted position by moving the sliding member 50. When pins 54, 58 are in this retracted position, the lower sash 18 may be tilted out of the frame 14, in a manner known in the art. In the retracted position, the lower sash does not engaged the holes 38, nor does it engage the frame, which allows the sash 18 to be able to be tilted in and out of the frame 14. Additionally, there is a third pin located on the bottom 34 of the lower sash 18 configured to vertically slide within the frame member located on or adjacent to the right inner vertical surfaces 42. Similarly, there is a fourth pin located on the bottom 34 of the lower sash 18 configured to vertically slide within the frame member located on or adjacent to the left inner vertical surfaces 48. These lower pins (not shown) are the pivot points for the lower sash 18, for when the sash 18 is tilted in and out of the window frame 14.

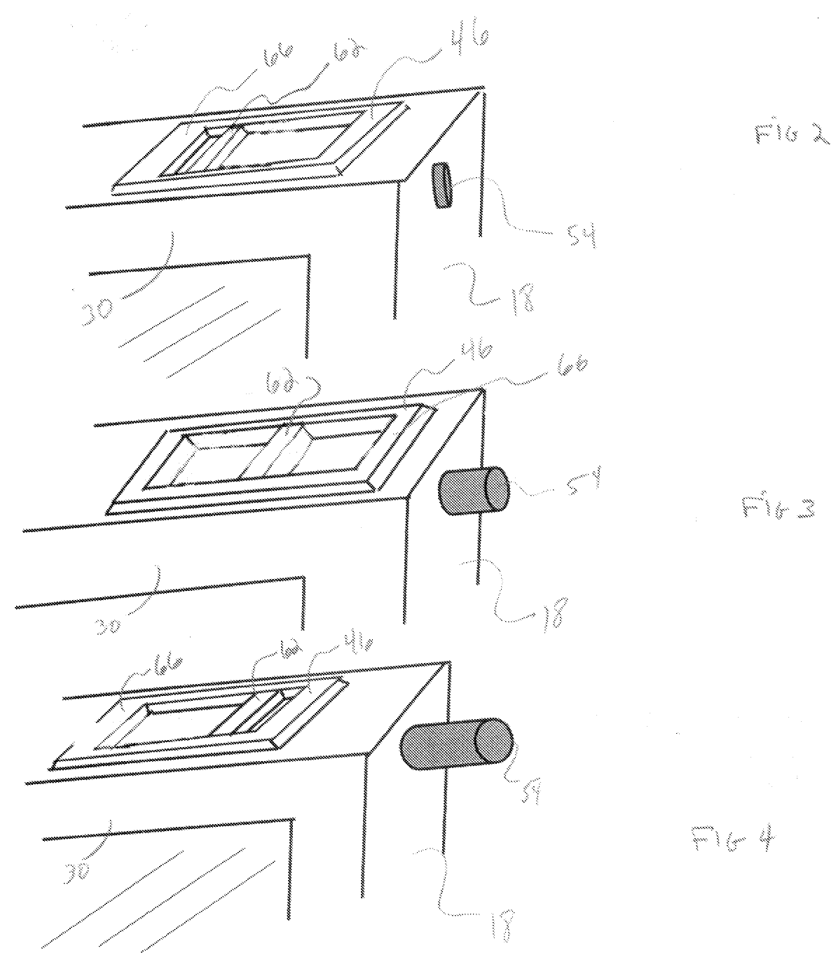

FIG. 3 shows another perspective close up view of the top 30 of the lower sash 18. In this view, the pin 54 is shown in a normal position. The pin 54 has been moved into this position by moving the sliding member 46. In this normal position, the pin 54 is not fully retracted into the top 30 of the sash 18, but rather is in a middle position between fully retracted and fully extended (as shown in FIG. 4). Although not shown, the pin 58, on the other side of the top 30 of the lower sash 18 may be put in the normal position by moving the sliding member 50. In this normal position, the pins 54, 58 do not engage the holes 38, but it does engage the frame 14 such that the lower sash 18 is not able to be tilted in or out of the frame 14. The pins 54, 58, in the normal position, engage the frame 14 via a frame member (not shown). The frame member maybe a rail, guide, or track in which the pins 54, 58 are able to move vertically within. However, the frame member prevents horizontal movement of the pins 54, 58, such that the lower sash 18 is unable to tilt in and out of the frame.

FIG. 4 shows another perspective close up view of the top 30 of the lower sash 18. In this view, the pin 54 is shown in an extended position. The pin 54 is put in this extended position by moving the sliding member 46. In this extended position, the pin 54 is fully extended such that it will engage one of the holes 38 on the right inner vertical surface 42. Although not shown, the pin 58, on the other side of the top 30 of the lower sash 18 may be put in the extended position too, by moving the sliding member 50, such that the pin 58 engages one of the holes 38 located on left inner vertical surface 48. When pins 54, 58 are in the extended position and each engaged in a hole 38, the lower sash 18 is locked in relation to the frame 14. Because there are a plurality of holes 38 located in the left inner surface 48, and right inner surface 42, the lower window sash 18 may be locked with respect to the frame 14 at different vertical heights with respect to the frame 14, depending on which pair of holes 38 the pins 54, 58 engage with.

The sliding members 46, 50 may be configured to be childproof, that is the may be configured to be difficult for a young child to operate. In one embodiment, the sliding members 46, 50 may require a user to both squeeze the members 46, 50 while sliding it, in order to move the sliding members 46, 50 and therefore the pins 54, 58. Of course, other known child proofing techniques may be incorporated into the sliding members 46. 50. Referring to FIGS. 2-4, it can be see that the first sliding member 46 is comprised a sliding element 62 that is moveable within the sliding element housing 66. The positing of the sliding element 62 within the sliding housing 66 corresponds to the position of the first pin 54, that is, whether the first pin 54 is in the retracted position, normal position, or extended position. Although not visible in this view, a similar arrangement exists for the second sliding element 50 and second pin 58. The second sliding member 50 is comprised of a sliding element 62 that is moveable within the sliding element housing 66. The position of the sliding element 62 within the sliding housing 66 corresponds to the position of the second pin 58, that is, whether the first pin 58 is in the retracted position, normal position, or extended position.

The disclosed safety window has many advantages. The safety window will assist in preventing children from opening windows, and perhaps injuring themselves. The safety window can prevent intruders from easily gaining access through the window, while allowing the window to remain open to allow the outside atmosphere or a breeze into the home.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A safety window comprising:
a window frame, with a right inner surface, a left inner surface, a top, and a bottom;
a lower sash in vertical slideable communication with window frame, the lower sash with a top and a bottom;
an upper sash in vertical slideable communication with the window frame, the upper sash with a top and a bottom;
a lock apparatus located on the top of the lower sash and the bottom of the upper sash and configured to reversibly lock the lower sash with respect to the upper sash, when locked the upper sash is located at the top of the frame, and the lower sash is located at the bottom of the frame;
a first plurality of holes located on the right inner surface of the window frame;
a second plurality of holes located on the left inner surface of the window frame;
a first extendible pin located in the top of the bottom sash, and configured to removeably engage at least one of the first plurality of holes;
a second extendible pin located in the top of the bottom sash, and configured to removeably engage at least one of the second plurality of holes;
a first sliding member located at the top of the bottom sash, and in operable communication with the first pin;
a second sliding member located at the top of the bottom sash, and in operable communication with the second pin;
a first frame member located on the interior right surface of the window frame, the first frame member configured to be slideable communication with the first extendible pin when the first extendible pin is in a normal position;
a second frame member located on the interior left surface of the window frame, the second frame member configured to be slideable communication with the second extendible pin when the second extendible pin is in a normal position.

2. The safety window of claim 1, wherein the first and second sliding members are child proof.

3. The safety window of claim 1, wherein the first and second sliding members can only be moved relative to the lower sash if the first and second sliding members are squeezed generally in the middle until a sliding member locking mechanism is released.

4. The safety window of claim 1, further comprising:
a third pin located in the bottom of the lower sash, and configured to vertically slide within the first frame member; and
a fourth pin located in the bottom of the lower sash, and configured to vertically slide within the second frame member.

5. The safety window of claim 1, wherein the first extendible pin and second extendible pin are configured to be moveable to a retracted position such that the lower sash can be tilted in and out of the window frame.

6. A safety window comprising:
a window frame, with a right inner surface, a left inner surface, a top, and a bottom;
a lower sash in vertical slideable communication with window frame, the lower sash with a top and a bottom;
an upper sash fixed in the window frame, the upper sash with a top and a bottom;
a lock apparatus located on the top of the lower sash and the bottom of the upper sash and configured to reversibly lock the lower sash with respect to the upper sash, when locked the upper sash is located at the top of the frame, and the lower sash is located at the bottom of the frame;
a first plurality of holes located on the right inner surface of the window frame;
a second plurality of holes located on the left inner surface of the window frame;
a first extendible pin located in the top of the bottom sash, and configured to removeably engage at least one of the first plurality of holes;
a second extendible pin located in the top of the bottom sash, and configured to removeably engage at least one of the second plurality of holes;
a first sliding member located at the top of the bottom sash, and in operable communication with the first pin;
a second sliding member located at the top of the bottom sash, and in operable communication with the second pin;
a first frame member located on the interior right surface of the window frame, the first frame member configured to be slideable communication with the first extendible pin when the first extendible pin is in a normal position;
a second frame member located on the interior left surface of the window frame, the second frame member configured to be slideable communication with the second extendible pin when the second extendible pin is in a normal position.

7. The safety window of claim 6, wherein the first and second sliding members are child proof.

8. The safety window of claim 6, wherein the first and second sliding members can only be moved relative to the lower sash if the first and second sliding members are squeezed generally in the middle until a sliding member locking mechanism is released.

9. The safety window of claim 6, further comprising:
a third pin located in the bottom of the lower sash, and configured to vertically slide within the first frame member; and
a fourth pin located in the bottom of the lower sash, and configured to vertically slide within the second frame member.

10. The safety window of claim 1, wherein the first extendible pin and second extendible pin are configured to be moveable to a retracted position such that the lower sash can be tilted in and out of the window frame.
